(19) United States
(12) Patent Application Publication
(10) Pub. No.: US 2016/0371102 A1
(43) Pub. Date: Dec. 22, 2016

(54) SYSTEM AND METHOD FOR SUPPORTING EXECUTION OF APPLICATION BASED ON MULTI-PLATFORM USING VIRTUAL PLATFORM SERVICE

(71) Applicant: Electronics and Telecommunications Research Institute, Daejeon (KR)

(72) Inventors: Sun-Wook KIM, Gyeonggi-do (KR); Dae-Won KIM, Daejeon (KR); Seong-Woon KIM, Chungcheongnam-do (KR); Jong-Bae MOON, Daejeon (KR); Byeong-Thaek OH, Daejeon (KR); Soo-Cheol OH, Daejeon (KR); Jung-Hyun CHO, Daejeon (KR); Hag-Young KIM, Daejeon (KR)

(21) Appl. No.: 15/049,544

(22) Filed: Feb. 22, 2016

(30) Foreign Application Priority Data
Jun. 17, 2015 (KR) 10-2015-0085599

(51) Int. Cl. G06F 9/455

(52) U.S. Cl. CPC G06F 9/455; G06F 9/45558; G06F 2009/45562

(57) ABSTRACT

A system and method for supporting the execution of an application based on a multi-platform are disclosed. The system for supporting the execution of an application based on a multi-platform includes a service server and a service center. The service server provides a virtual platform for executing an application based on a multi-platform. The virtual platform corresponds to virtual platform selection information from a service client. The service center provides an application based on a heterogeneous operating system (OS) based on installation-desired application selection information from the service client.

### CROSS-REFERENCE TO RELATED APPLICATION

This application claims the benefit of Korean Patent Application No. 10-2015-0085599, filed Jun. 17, 2015, which is hereby incorporated by reference herein in its entirety.

### BACKGROUND

1. Technical Field

The present disclosure relates generally to a system and method for supporting the execution of an application based on a multi-platform using cloud-based virtual platform service, and more particularly to a system and method for supporting the execution of an application based on heterogeneous and homogeneous operating systems (OSs) using server virtualization-based virtual platform service.

2. Description of the Related Art

In general, to install an application, desired by a user, on a mobile computing device or personal computer, it is necessary to select, install and then use applications that are dependent on the operating system (OS) of the corresponding device.

To enable the same application to be used on various OSs, a disadvantage arises in that a developer must develop various versions of applications or use independent developing technologies.

Furthermore, to enable an application to be executed on all terminals, technologies for supporting web-based OS and web browser-based application execution have been recently introduced.

However, such web-based applications are limited in that they do not provide access to local system resources, such as a file system, a basic window, a graphics processor, a microphone, and a camera, and provide a somewhat limited security model compared to a local system.

Furthermore, users are experiencing difficulty in applying various and complicated technologies for executing applications based on heterogeneous OSs, such as application virtualization, emulation and a sandbox, to their own computing devices.

Currently, a plurality of users have installed applications dependent on their own computing devices using online an app store or local media. That is, users desire to connect with specific services and use their desired applications without complicated settings and program installation.

That is, there is a need for a system and method for supporting the execution of a multi-platform application platform, which can provide convenience in which a user can generate his or her own data using his or her desired application regardless of his or her computing device and platform, can overcome complexity and redundancy in which application developers develop various versions of programs, and can provide the convenience of the management of various user computing-based services upon providing cloud-based service.

Conventional technologies related to the present invention include Korean Patent Application Publication No. 2010-0138980 entitled “Method and System for Detecting Installation and Use of Software in Application Virtual Environment,” Korean Patent Application Publication No. 2013-0086138 entitled “Cross-platform Application Framework,” Korean Patent Application Publication No. 2011-0082222 entitled “Virtual Platform System and Method for Processing of Application,” International Publication No. WO/2014/052380 entitled “Cross System Installation of Web Applications,” and U.S. Patent Application Publication No. US2013/0091557 entitled “System and Method for Providing Cloud-based Cross-platform Application Stores for Mobile Computing Devices.”

### SUMMARY

At least some embodiments of the present invention are directed to the provision of a system and method for supporting the execution of an application based on a multi-platform, which apply technology for supporting the execution of an application based on a multi-platform to server virtualization-based virtual platform service for supporting various user terminals and local resource use, thereby supporting the use of an application based on heterogeneous and homogeneous OSs without requiring a user to perform separate setting or program installation.

In accordance with an aspect of the present invention, there is provided a system for supporting the execution of an application based on a multi-platform, including: a service server configured to provide a virtual platform for executing an application based on a multi-platform, wherein the virtual platform corresponds to virtual platform selection information from a service client; and a service center configured to provide an application based on a heterogeneous operating system (OS) based on installation-desired application selection information from the service client.

The service server may generate and execute the virtual platform based on virtualization software (SW).

The service server may include: a virtualization SW configured to abstract the computing resources of a physical server system, and to dynamically configure and assign required resources to higher SW; a virtual platform delivery layer configured to connect with virtualized hardware devices generated by the virtualization SW, to collect data, and to transfer the collected data to the service client; and the virtual platform configured to be generated by the virtualization SW.

The virtualization SW may be installed on a host OS, and may generate a virtual machine based on the host OS.

The virtualization SW may generate the virtual platform based on the generated virtual machine.

The virtual platform may be based on an open SW OS.

The virtual platform may include: a virtual API bridge configured to support the installation and execution of an application running on an OS different from the OS of the corresponding virtual platform; an application administrator configured to support the installation of a new application, and to support the state monitoring and deletion of an application installed on the corresponding virtual platform; and a user interface control module.

The virtual API bridge may make virtual platform service for supporting the execution of an application based on a multi-platform available.

The application administrator may be provided to the service client using the virtual platform in a graphical user interface (GUI) form.

The application administrator may provide a list of applications installable on the corresponding virtual platform to the service client.

The application administrator may receive library and predetermined setting files required for a program based on the heterogeneous OS from the service center, and may support installation and execution thereof.

The user interface control module may provide various OS user interfaces so that the service client can select and use a familiar interface.

The service center may include a platform management engine configured to connect with the service server, to monitor the usage of the physical computing resources of a corresponding server and usage of virtual computing resources of the virtual platform, to manage the load balance of the service server, to control the execution of the virtual platform and the state of the virtual platform, and to manage the dynamic power of the service server.

The service center may further include an application management engine configured to connect with the virtual platform, to monitor the installation file transmission of an application and update and usage status by an administrator, to provide an interface for the management of storage for the corresponding application to the administrator, and to provide the function of storing a new application.

The service center may further include a client management engine configured to receive a connection request transmitted by the service client and to manage user authentication, new user addition, deletion, and a connection state.

In accordance with another aspect of the present invention, there is provided a method of supporting execution of an application based on a multi-platform, including: connecting, by a service client, with a virtual platform generated by a service server, and requesting, by the service client, virtual platform service; selecting, by the service client, the user interface of a virtual platform to be used; checking, by the service client, whether an application desired for use on the virtual platform has been installed; selecting, by the service client, an installation-desired application if the application desired for use has not been installed; if the selected application is a heterogeneous OS application, connecting, by the service client, with a service center, and receiving, by the service client, installation, predetermined and execution library files of the corresponding application; and installing, by the service client, the received application.

The method may further include, if the selected application is a homogeneous application, selecting, by the service client, the location of an installation file within a virtual platform or service center, and installing, by the service client, the corresponding application.

In accordance with another aspect of the present invention, there is provided a method of supporting the execution of an application based on a multi-platform, including: receiving, by a service server, a request for virtual platform service from a service client that has connected with a virtual platform; checking, by the service server, whether an application that the service client desires to use has been installed on the virtual platform; and if, as a result of the checking, the application has not been installed and when the service client selects installation of a heterogeneous OS application, providing, by a service center, an installation file of the corresponding application to the service client.

The method may further include, if, as a result of the checking, the application has not been installed and when the service client selects installation of a homogeneous application, providing, by the service server, the installation file of the corresponding application to the service client.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a system for supporting the execution of an application based on a multi-platform according to an embodiment of the present invention;

FIG. 2 is a diagram showing the internal configuration of each of the service servers shown in FIG. 1;

FIG. 3 is a diagram showing the internal configuration of the service center shown in FIG. 1;

FIG. 4 is a diagram showing the internal configuration of the service client shown in FIG. 1;

FIG. 5 is a flowchart showing a method of supporting the execution of an application based on a multi-platform according to an embodiment of the present invention, with a focus on a service client; and

FIG. 6 is a flowchart showing a method of supporting the execution of an application based on a multi-platform according to an embodiment of the present invention, which is a flowchart that is illustrated from the perspective of a service server and a service center.

### DETAILED DESCRIPTION

The present invention may be subjected to various modifications, and may have various embodiments. Specific embodiments are illustrated in the drawings, and are described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and are not used to limit the present invention. A singular form may include a plural form unless otherwise defined. The terms, including “comprise,” “includes,” “comprising,” “including” and their derivatives, specify the presence of described shapes, numbers, steps, operations, elements, parts and/or groups thereof, and do not exclude the presence or addition of one or more other shapes, numbers, steps, operations, elements, parts, and/or groups thereof.

Unless otherwise defined herein, all terms including technical or scientific terms used herein have the same meanings as commonly understood by those skilled in the art to which the present invention pertains. It will be further understood that terms, such as those defined in commonly used dictionaries, should be interpreted as having meanings that are consistent with their meanings in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference symbols are assigned to like components throughout the drawings and redundant descriptions of the like components are omitted.

The present invention is directed to a virtual platform system for supporting the execution of an application based on a multi-platform, and focuses on a system and method for supporting the execution of an application based on heterogeneous and homogeneous OSs on a server virtualization-based virtual platform.

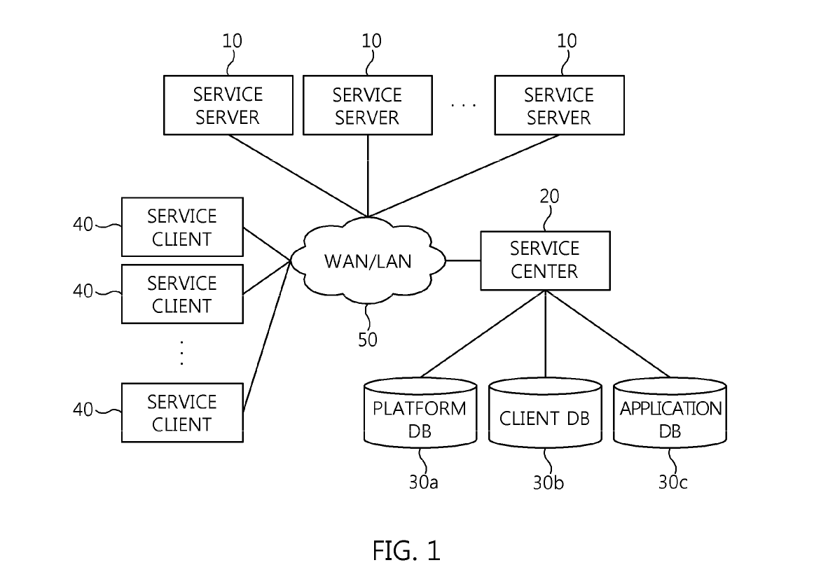

FIG. 1 is a diagram showing the configuration of a system for supporting the execution of an application based on a multi-platform according to an embodiment of the present invention, which is the configuration of a system for providing virtual platform service for the execution of a multi-platform application based on a virtual platform infrastructure.

In the system of FIG. 1, a plurality of service servers 10, a single service center 20, and a plurality of service clients 40 are connected to each other over a network 50, for example, a WAN and/or a LAN.

The service server 10 provides a virtual platform for executing an application based on a multi-platform. In other words, the service server 10 generates and executes virtual platforms based on virtualization SW.

The service center 20 provides server (for example, a web server), platform, client and application management functions.

Furthermore, the service center 20 separately maintains and manages databases (DBs) for storing respective types of information (for example, a platform database (DB) 30a, a client DB 30b, and an application DB 30c). In this case, the server and platform management function for virtual platform service is responsible for the monitoring and control of the performance/state of a server and a virtual platform. Information about the server and platform management function may be stored in the platform DB 30a. The client management function manages the information and authentication of a user, virtual platform assignment, connection state, etc. Information about the client management function may be stored in the client DB 30b. Furthermore, the application management function monitors the registration, deletion, transfer, usage frequency, etc. of applications that are provided to a virtual platform. Information about the application management function may be stored in the application DB 30c.

Furthermore, the corresponding information stored in the DBs 30a, 30b and 30c is provided to an administrator via a web-based graphic user interface GUI. The administrator manages servers, a virtual platform, clients, and applications via a web-based graphic user interface (GUI).

The service clients 40 may receive their desired virtual platform services over the network 50 regardless of their computing device and platform.

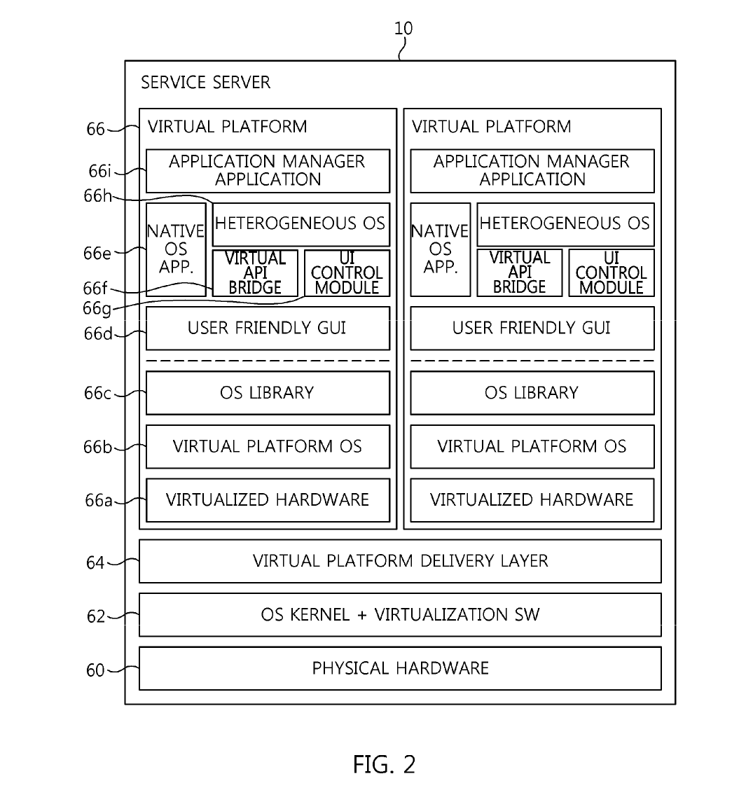

FIG. 2 is a diagram showing the internal configuration of each of the service servers 10 shown in FIG. 1.

The service server 10 includes physical hardware 60, host OS-based virtualization SW (OS kernel+virtualization SW) 62, a virtual platform delivery layer 64, and virtual platforms 66.

The host OS-based virtualization SW 62 may abstract the computing resources (for example, a CPU, memory, and I/O devices) of a physical server system, and may dynamically configure and assign required resources to higher SW. The host OS-based virtualization SW 62 is commonly used as a hypervisor or a virtual machine monitor (VMM), and may be installed on a host OS and generate virtual machine based on this. Furthermore, the host OS-based virtualization SW 62 may generate the virtual platforms 66 based on the generated virtual machines. Accordingly, users (i.e., the service clients 40) may access the virtual platforms 66 over the network 50, and may receive virtual platform service.

The virtual platform delivery layer 64 may access virtualized hardware devices generated by the host OS-based virtualization SW 62, may collect data, and may transfer the collected data to a user (i.e., the service client 40) via transmission protocol. Accordingly, a user, i.e., the service client 40, may record virtual platform display and user input based on the corresponding data.

In this case, the virtual platform 66 generated based on the host OS-based virtualization SW 62 may support various types of OSs. When open SW is used as an OS for the virtual platform 66 and support the execution of a multi-platform application, license expenses required for the use of a commercial OS and access to the commercial OS may be reduced.

When executing the virtual platform 66, a user may select an OS UI with which he or she is familiar. That is, when a Windows user selects a Windows UI and executes a corresponding virtual platform 66, a UI similar to that of Windows may be installed on an open SW OS UI. This is managed by a UI control module 66g located above a user friendly GUI 66d inside the virtual platform 66.

Meanwhile, the virtual API bridge 66f engages when an application (i.e., a heterogeneous OS application 66h) running on an OS different from the OS of the virtual platform 66 is installed and executed on the user friendly GUI 66d, and supports the smooth execution of the corresponding application. Furthermore, the virtual API bridge 66f makes service for supporting the execution of an application based on a multi-platform virtual platform available. Furthermore, the virtual API bridge 66f also supports the execution of an application (i.e., a native OS application 66e) running on an OS identical to the OS of the virtual platform 66.

The application administrator 66i of the virtual platform 66 is provided to a user, who uses the virtual platform 66, in the form of a GUI. Furthermore, the application administrator 66i supports the installation of a new application, monitors the state of an application installed on the corresponding virtual platform 66, and supports the deletion of the application. Meanwhile, the application administrator 66i may be viewed as an application management module or unit.

Furthermore, the application administrator 66i may provide a list of applications installable on the corresponding virtual platform 66 to a user. Accordingly, in the case of a heterogeneous application when a new application is installed, the user (i.e., the service client 40) may receive library, installation and predetermined setting files required for execution via an application management engine running in the service center 20 and install them by means of the virtual API bridge 66f. In the case of a homogeneous application, installation file storage is selected and installation is performed.

In FIG. 2, reference symbol 66a denotes virtualized hardware, reference symbol 66b denotes a virtual platform OS, and reference symbol 66c denotes an OS library.

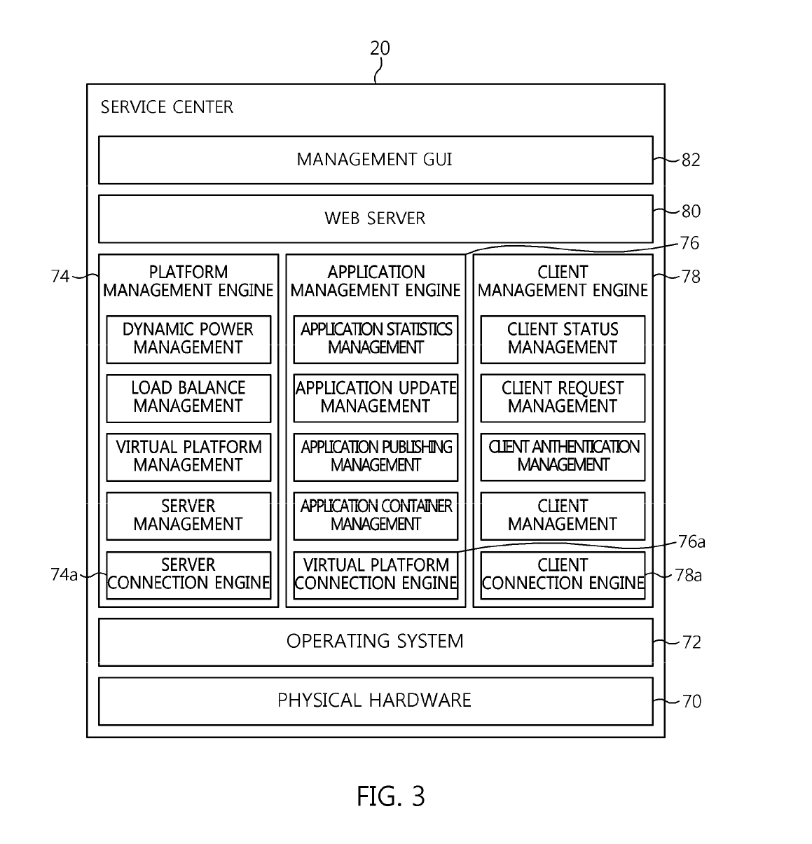

FIG. 3 is a diagram showing the internal configuration of the service center 20 shown in FIG. 1.

The service center 20 provides a service server, virtual platform, application and user management function.

A platform management engine platform management engine 74 inside the service center 20 may access the service servers 10, and may monitor the usage of the physical computing resources of the servers and the usage of the virtual computing resources of the virtual platforms in real time. In other words, the platform management engine 74 may provide a server management function. Accordingly, the platform management engine 74 includes a server connection engine 74a for connection with the service servers 10.

Furthermore, the platform management engine 74 may manage load balance between the individual servers through the distribution of the virtual platforms 66 running on the service servers 10 based on monitoring information. In other words, the platform management engine 74 may provide a load balance management function.

Furthermore, the platform management engine 74 may control the execution and states of the virtual platforms 66, and may be responsible for the generation and assignment of the virtual platforms for users. In other words, the platform management engine 74 may provide a virtual platform management function.

The platform management engine 74 may provide the dynamic power management function of moving virtual platforms 66 distributed and running at a various locations to a single service server 10 and stopping the remaining servers based on the resource usage and virtual platform usage of the service servers 10.

The application management engine 76 within the service center 20 may access the virtual platforms 66 over the network 50, and may monitor the installation file transmission of an application and update by the administrator, and usage. Accordingly, the application management engine 76 includes a virtual platform connection engine 76a for connection with the virtual platforms 66.

Furthermore, the application management engine 76 may provide an interface for the management of corresponding application storage to the administrator, and may provide the function of deleting an application has a low usage frequency and storing a new application.

The client management engine 78 within the service center 20 may receive a connection request transmitted by the service client 40, and may manage user authentication, new user addition, user deletion, and a connection state. Accordingly, the client management engine 78 includes a client connection engine 78a for connection with the service clients 40.

In FIG. 3, reference symbol 70 denotes physical hardware, reference symbol 72 denotes an OS, reference symbol 80 denotes a web server, and reference symbol 82 denotes a management GUI.

Meanwhile, the platform management engine 74, application management engine 76, and client management engine 78 shown in FIG. 3 may be viewed as a platform management module or unit, an application management module or unit, and a client management module or unit, respectively.

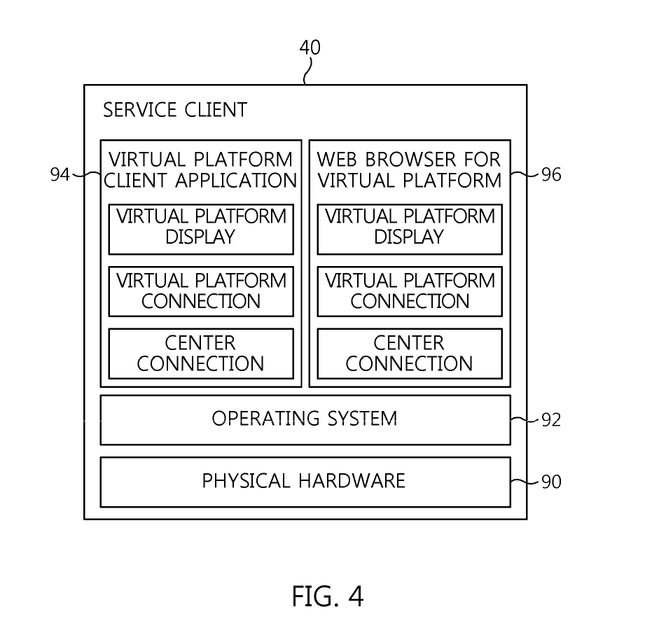

FIG. 4 is a diagram showing the internal configuration of the service client 40 shown in FIG. 1.

The service client 40 may provide modules (i.e., a virtual platform client application 94, and a web browser for virtual platform 96) for connection with the service center 20 and the virtual platform 66, respectively.

Accordingly, the service client 40 may provide the center connection function of requesting virtual platform connection adapted to receive the transmission protocol of the virtual platform 66 and play back it on a client terminal and user authentication.

As described above, the client connection may be provided in the form of an application and in the form of a web browser.

In FIG. 4, reference symbol 90 denotes physical hardware, and reference symbol 92 denotes an OS.

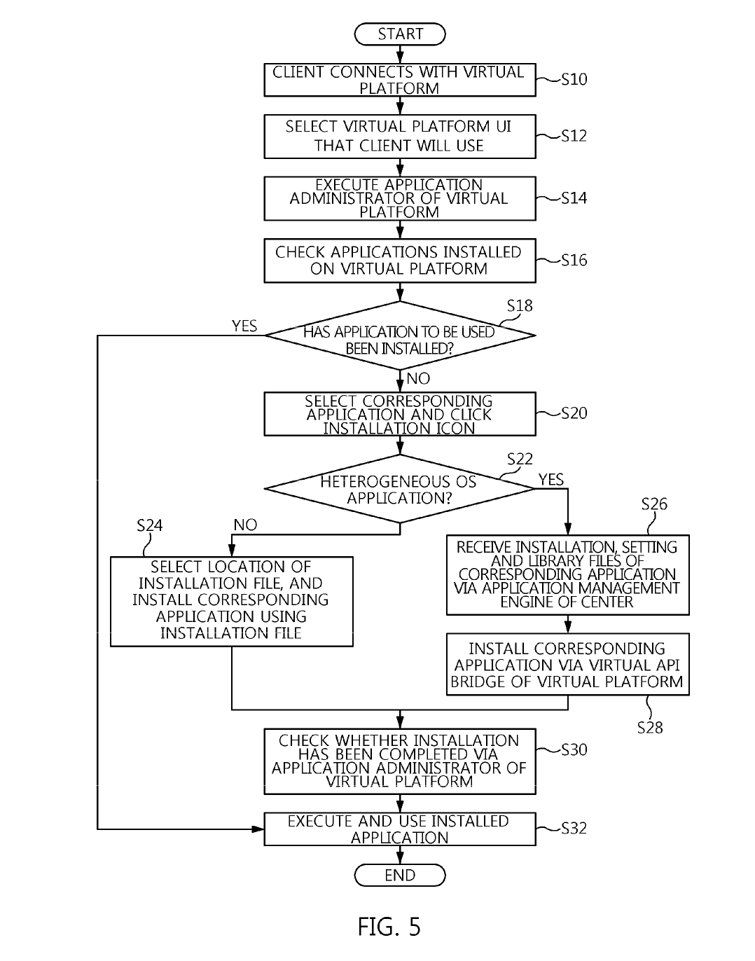

FIG. 5 is a flowchart showing a method of supporting the execution of an application based on a multi-platform according to an embodiment of the present invention. FIG. 5 is a flowchart that provides an illustration with a focus on the service client 40.

First, a user (i.e., the service client 40) connects with the virtual platform generated in the service server 10 and requests virtual platform service at step S10.

Thereafter, the user (i.e., the service client 40) selects an OS user interface UI with which he or she is familiar at step S12. Accordingly, when the corresponding virtual platform is executed, the user interface selected by the client is applied to the service client 40.

In this case, the user (i.e., the service client 40) may execute the application administrator 66i of the service server 10 at step S14, and checks whether a desired application has been installed on the corresponding virtual platform via the execution of the application administrator 66i at step S16.

If, as a result of the checking, the desired application has not been installed (“No” at step S18), the service server 10 notifies the service client 40 that the corresponding application has not been installed. Accordingly, the user (i.e., the service client 40) selects a desired application and clicks an installation icon at step S20.

Furthermore, if the selected application is a homogeneous application (“No” at step S22), the service center 20 provides notification of the registered location of the installation file of the corresponding application. The registered location may be the service server 10 or service center 20. Furthermore, it may be possible to select and install an application that is possessed by the service client. In this case, the location of the installation file of the application may be determined via, for example, an application list. Accordingly, the user (i.e., the service client 40) selects the location of the installation file and installs the corresponding application at step S24. Thereafter, the user (i.e., the service client 40) checks that the installation has been completed via the application administrator 66i of the service server 10 at step S30 and executes the installation application at step S32.

In contrast, if the selected application is a heterogeneous OS application (“Yes” at step S22), the user (i.e., the service client 40) connects with the application management engine (i.e., the application management engine 76) of the service center 20 and receives the installation, predetermined setting and library files of the corresponding application at step S26. Thereafter, the user (i.e., the service client 40) installs the corresponding application via the virtual API bridge 66f of the service server 10 at step S28. Thereafter, the user (i.e., the service client 40) checks that the installation has been completed via the application administrator 66i of the service server 10 at step S30 and executes the installation application at step S32.

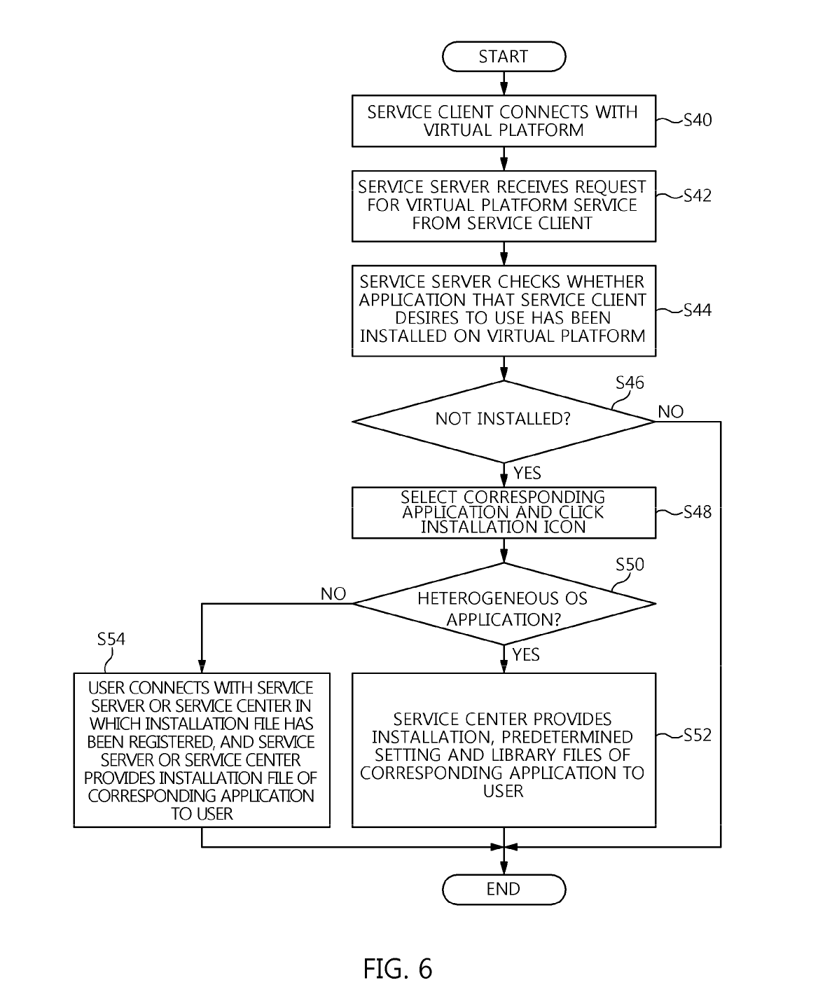

In this case, referring to the flowchart of FIG. 6, a method of supporting the execution of an application based on a multi-platform from the perspective of the service server 10 and the service center 20.

First, the user (i.e., the service client 40) connects with the virtual platform 66 generated in the service server 10 at step S40.

Accordingly, the service server 10 receives a request for virtual platform service from the service client 40 that has connected with the virtual platform 66 at step S42.

Thereafter, as the user selects an OS UI with which the user is familiar, the user interface selected by the user is applied to the service client 40 when the corresponding virtual platform is executed.

Thereafter, the user executes the application administrator 66i in order to check whether an application that the user desires to use has been installed on the corresponding virtual platform.

Accordingly, the application administrator 66i of the service server 10 is executed and checks whether the application that the user desires to use has been installed on the corresponding virtual platform at step S44.

If, as a result of the checking, the application that the user desires to use has not been installed (“Yes” at step S46), the user selects an application that the user desires to install, and clicks an installation icon.

If the application selected by the user is a heterogeneous OS application (“Yes” at step S50), the service center 20 provides the installation, predetermine setting and library files of the corresponding application to the user (i.e., the service client 40) at step S52.

If the application that is selected by the user is a homogeneous application (“No” at step S50), the user connects with the service server 10 or service center 20 in which an installation file has been registered and the service server 10 or service center 20 provides the installation file of the corresponding application to the user, i.e., the service client 40 at step S54. Furthermore, it may be possible to select and install an application that is possessed by a service client.

In at least some embodiments of the present invention, there are provided a system and method for supporting the execution of an application based on a multi-platform, which apply technology for supporting the execution of an application based on a multi-platform to server virtualization-based virtual platform service for supporting various user terminals and local resource use, thereby supporting the use of an application based on heterogeneous and homogeneous OSs without requiring a user to perform separate setting or program installation.

This enables users to generate their own data using their desired applications regardless of their computing devices and platforms.

Furthermore, application developers can solve complexity and redundancy regarding the development of various versions of programs, and can provide cloud-based virtual platform service optimized for various user computing environments.

As described above, the exemplary embodiments have been disclosed in the present specification and the accompanying drawings. Although the specific terms have been used herein, they have been used merely for the purpose of describing the present invention, but have not been used to restrict the meanings thereof or limit the scope of the present invention set forth in the attached claims. Accordingly, it will be appreciated by those having ordinary knowledge in the relevant technical field that various modifications and other equivalent embodiments can be made. Therefore, the true range of protection of the present invention should be defined based on the technical spirit of the attached claims.

What is claimed is:

1. A system for supporting execution of an application based on a multi-platform, comprising:
a service server configured to provide a virtual platform for executing an application based on a multi-platform, wherein the virtual platform corresponds to virtual platform selection information from a service client; and
a service center configured to provide an application based on a heterogeneous operating system (OS) based on installation-desired application selection information from the service client.

2. The system of claim 1, wherein the service server generates and executes the virtual platform based on virtualization software (SW).

3. The system of claim 1, wherein the service server comprises:
a virtualization SW configured to abstract computing resources of a physical server system, and to dynamically configure and assign required resources to higher SW;
a virtual platform delivery layer configured to connect with virtualized hardware devices generated by the virtualization SW, to collect data, and to transfer the collected data to the service client; and
the virtual platform configured to be generated by the virtualization SW.

4. The system of claim 3, wherein the virtualization SW is installed on a host OS, and generates a virtual machine based on the host OS.

5. The system of claim 4, wherein the virtualization SW generates the virtual platform based on the generated virtual machine.

6. The system of claim 3, wherein the virtual platform is based on an open SW OS.

7. The system of claim 3, wherein the virtual platform comprises:
a virtual API bridge configured to support installation and execution of an application running on an OS different from an OS of the corresponding virtual platform;
an application administrator configured to support installation of a new application, and to support state monitoring and deletion of an application installed on the corresponding virtual platform; and
a user interface control module.

8. The system of claim 7, wherein the virtual API bridge makes virtual platform service for supporting the execution of an application based on a multi-platform available.

9. The system of claim 7, wherein the application administrator is provided to the service client using the virtual platform in a graphical user interface (GUI) form.

10. The system of claim 9, wherein the application administrator provides a list of applications installable on the corresponding virtual platform to the service client.

11. The system of claim 7, wherein the application administrator receives library and predetermined setting files required for a program based on the heterogeneous OS from the service center, and supports installation and execution thereof.

12. The system of claim 7, wherein the user interface control module provides various OS user interfaces so that the service client can select and use a familiar interface.

13. The system of claim 1, wherein the service center comprises a platform management engine configured to connect with the service server, to monitor usage of physical computing resources of a corresponding server and usage of virtual computing resources of the virtual platform, to manage load balance of the service server, to control execution of the virtual platform and a state of the virtual platform, and to manage dynamic power of the service server.

14. The system of claim 13, wherein the service center further comprises an application management engine configured to connect with the virtual platform, to monitor installation file transmission of an application and update and usage status by an administrator, to provide an interface for management of storage for the corresponding application to the administrator, and to provide a function of storing a new application.

15. The system of claim 14, wherein the service center further comprises a client management engine configured to receive a connection request transmitted by the service client and to manage user authentication, new user addition, deletion, and a connection state.

16. A method of supporting execution of an application based on a multi-platform, comprising:
connecting, by a service client, with a virtual platform generated by a service server, and requesting, by the service client, virtual platform service;
selecting, by the service client, a user interface of a virtual platform to be used;
checking, by the service client, whether an application desired for use on the virtual platform has been installed;
selecting, by the service client, an installation-desired application if the application desired for use has not been installed;
if the selected application is a heterogeneous OS application, connecting, by the service client, with a service center, and receiving, by the service client, installation, predetermined and execution library files of the corresponding application; and
installing, by the service client, the received application.

17. The method of claim 16, further comprising, if the selected application is a homogeneous application, selecting, by the service client, a location of an installation file within a virtual platform or service center, and installing, by the service client, the corresponding application.

18. A method of supporting execution of an application based on a multi-platform, comprising:
receiving, by a service server, a request for virtual platform service from a service client that has connected with a virtual platform;
checking, by the service server, whether an application that the service client desires to use has been installed on the virtual platform; and
if, as a result of the checking, the application has not been installed and when the service client selects installation of a heterogeneous OS application, providing, by a service center, an installation file of the corresponding application to the service client.

19. The method of claim 18, further comprising, if, as a result of the checking, the application has not been installed and when the service client selects installation of a homogeneous application, providing, by the service server, an installation file of the corresponding application to the service client.
